(19) United States
(12) Patent Application Publication
(10) Pub. No.: US 2013/0009430 A1
(43) Pub. Date: Jan. 10, 2013

(54) ENERGY ABSORBER

(75) Inventors: Rakibul ISLAM, Mission Viejo, CA (US); Robert W. TRIMBLE, Gainesville, TX (US); Raul Daniel Flores AGUIRRE, Chihuahua (MX); Frederic QUATANENS, Issoudon (FR); Jeremy CAILLETEAU, St. Aout (FR); Jeremy GAUDIN, Saint-Maur (FR); Virgile MARTINEZ, Segry (FR); Jean-Marc OBADIA, Maubec (FR)

(73) Assignee: ZODIAC AEROSPACE, Issoudun (FR)

(21) Appl. No.: 13/543,933

(22) Filed: Jul. 9, 2012

Related U.S. Application Data
(60) Provisional application No. 61/505,138, filed on Jul. 7, 2011.
(60) Provisional application No. 61/614,661, filed on Mar. 23, 2012.

(51) Int. Cl. B60R 21/207; B60N 2/427

(52) U.S. Cl. 297/216.1; 280/748

(57) ABSTRACT

Described are energy absorbers for a structure within a vehicle cabin having at least one airbag, an inflator, a control module, and an outer surface positioned adjacent the airbag. The outer surface may include a plurality of mechanical energy absorbers positioned adjacent the airbag and coupled to the outer surface, wherein the outer surface comprises a surface area that is greater than an inflated surface area of the airbag. The outer surface may also include a breakable area positioned adjacent the airbag, wherein the breakable area has a weaker coupling to the outer surface on at least a first side and a stronger coupling to the outer surface on at least a second side.

### CROSS REFERENCE TO RELATED APPLICATION

This application is related to and claims priority benefits from U.S. Provisional Application Ser. No. 61/505,138, filed on Jul. 7, 2011, entitled PNEUMATIC & MECHANICAL ENERGY ABSORBER, (the “'138 application”) and U.S. Provisional Application Ser. No. 61/614,661, filed on Mar. 23, 2012, entitled PNEUMATIC & MECHANICAL ENERGY ABSORBER (the “'661 application”). The '138 and '661 applications are hereby incorporated herein in their entireties by this reference.

### FIELD OF THE INVENTION

The invention relates to energy absorbers for passenger seats or the like.

### BACKGROUND

In various modes of transportation, many passenger seats are at least partially surrounded by walls or monuments or may be placed behind other passenger seats where items are mounted to the seat back, such as video displays, telephones, shrouds, or other items.

During a minor crash landing, a passenger may be thrown forward so that the passenger's head and/or body strikes these structures due to inertial loads from the event. Typically, these structures are rigid in nature, so as not to provide any energy absorbing or deflecting features. As a result, FIG. 1 shows typical head acceleration data on conventional monument designs, which is a measure of the likelihood of a head injury arising from an impact or Head Injury Criterion (“HIC”). As is shown in FIG. 1, the higher spikes represent a greater danger of head injury. The current method to address HIC risks has been primarily through spacing to eliminate contact with the structures during the dynamic event. See 14 C.F.R. §25.562.

Also, some passenger seats have been outfitted with an inflatable bag located in the seat belt to protect the passenger from head injury. However, the seat belt in these cases may be heavy, uncomfortable, and expensive. Furthermore, the success of the seat belt in preventing such injuries is dependent on specific interior layouts and installation.

Thus, it may be desirable to provide internal structures with energy absorbing and/or energy deflecting features within a potential strike zone to reduce and/or control the amount of head acceleration a passenger experiences during a minor crash. It may also be desirable to provide energy absorbing structures that are cost effective by reducing the overall weight of seats that otherwise incorporate inflatable restraints into the seat belts. It may further be desirable to provide energy absorbing structures that reduce the allowable setback for non-contact installations.

### SUMMARY

Embodiments of the present invention include an energy absorber for a structure within a vehicle cabin comprising a plurality of airbags, an inflator coupled to the plurality of airbags, wherein the inflator comprises a canister and a firing module, a control module electrically connected to the firing module of the inflator, and an outer surface positioned adjacent the plurality of airbags, wherein the outer surface comprises a surface area that is greater than an inflated surface area of the plurality of airbags. The structure may be a monument or a passenger seat back. In some embodiments, the outer surface may comprise a plurality of mechanical energy absorbers positioned adjacent the plurality of airbags and coupled to the outer surface.

In other embodiments, the outer surface may comprise a breakable area positioned adjacent the plurality of airbags, wherein the breakable area comprises a weaker coupling to the outer surface on at least a first side and a stronger coupling to the outer surface on at least a second side. In these embodiments, a hinge comprising a first end may be coupled to the breakable area and a second end may be coupled to a remainder of the outer surface, wherein the first end and the second end may be connected via a flexible connector. The breakable area may be formed of composite materials, glass fibers, fabric, or Kevlar with resin. The breakable area may also be displaced approximately 2 to 4 inches during inflation of the plurality of airbags.

In certain embodiments, the outer surface may be coupled to the inner surface in a deflector deployed configuration so that a central portion of the outer surface is displaced from the inner surface when the plurality of airbags are inflated or in an absorber deployed configuration so that the outer surface is displaced from the inner surface when the plurality of airbags are inflated. The control module may include integrated logic to monitor for crash scenarios and to deploy the energy absorber when such a scenario is detected.

Embodiments of the present invention may further comprise a monument for a passenger seat comprising an inner surface, an outer surface spaced apart from the inner surface, an energy absorber comprising at least one airbag positioned in the space between the inner surface and the outer surface, an inflator coupled to the at least one airbag, wherein the inflator comprises a canister and a firing module, and a control module electrically connected to the firing module of the inflator, and at least one mechanical energy absorber positioned adjacent the at least one airbag and coupled to the inner surface and the outer surface.

### BRIEF DESCRIPTION OF THE DRAWINGS

FIG. 1 is a graph showing typical head accelerations on conventional monument designs.

FIG. 2 is a rear perspective view of energy absorbers according to certain embodiments of the present invention positioned within a pair of passenger seat backs, wherein one energy absorber is deployed behind a seat back component and a second energy absorber is deployed in front of a seat back component.

FIG. 3 is a perspective view of an airbag of the energy absorber of FIG. 2 mounted to an inner surface of a structure.

FIG. 4 is a perspective view of the airbag of FIG. 3 with an outer surface positioned adjacent the airbag.

FIG. 5 is a perspective view of the airbag of FIG. 3.

FIG. 6 is a perspective view of an inflator of the energy absorber of FIG. 2.

FIG. 7 is a perspective view of a control module of the energy absorber of FIG. 2.

FIG. 8 is a perspective view of the control board within the control module of FIG. 7.

FIG. 9 is a rear perspective view of the pair of passenger seat backs of FIG. 2, wherein potential head strike zones are indicated in broken lines.

FIG. 10 is a rear perspective view of a passenger seat monument, wherein potential head strike zones are indicated in broken lines.

FIG. 11 is a rear perspective view of cabin furniture, wherein a potential head strike zone is indicated in broken lines.

FIG. 12 is a rear perspective view of the energy absorber of FIG. 2 positioned within a passenger seat monument, wherein the energy absorber is deployed through an outer surface of the passenger seat monument and a potential head strike zone is indicated in broken lines.

FIG. 13 is a perspective view of two energy absorbers of FIG. 2, wherein one energy absorber is configured to have a deflector deployed configuration and the other energy absorber has an absorber deployed configuration.

FIG. 14 is a top perspective view of the energy absorbers of FIG. 13.

FIG. 15 is a perspective view of the energy absorber of FIG. 2 positioned within a structure, wherein the energy absorber is deployed in an absorber deployed configuration and is positioned to form a crash surface for a passenger's entire body.

FIG. 16 is a perspective view of two energy absorbers of FIG. 2 positioned within a structure, wherein the energy absorbers are deployed in an absorber deployed configuration and are positioned to form a crash surface for a passenger's head and knees.

FIG. 17 is a perspective view of the energy absorber of FIG. 2 positioned within a structure, wherein the energy absorber is deployed in an absorber deployed configuration and is positioned to form a crash surface for a passenger's head.

FIG. 18 is a partial perspective view of a mechanical energy absorber in combination with the energy absorber of FIG. 2, wherein the energy absorber is deployed in an absorber deployed configuration.

FIG. 19 is a rear perspective view of the energy absorber of FIG. 2 positioned within the passenger seat monument of FIG. 10, wherein the energy absorber is deployed in an absorber deployed configuration and a passenger's head is shown striking the energy absorber.

FIG. 20 is a partial front perspective view of the energy absorber of FIG. 2 positioned within the passenger seat monument of FIG. 12, wherein the energy absorber is deployed in an absorber deployed configuration.

FIG. 21 is a cross sectional side view of a conventional structure.

FIG. 22 is a cross sectional side view of the structure of FIG. 21 with the energy absorber of FIG. 2 positioned within the structure of FIG. 21 and a rear view of a breakable area of an outer surface of the structure of FIG. 21.

FIG. 23 is a perspective view of the breakable area of FIG. 22 coupled to a hinge by bonding.

FIG. 24 is a perspective view of the breakable area of FIG. 22 coupled to a hinge by sewing.

FIG. 25 is a perspective view of the breakable area of FIG. 22 coupled to a hinge by mechanical fasteners.

FIG. 26 is a perspective view of the breakable area of FIG. 22 comprising a plurality of airbags.

FIG. 27 is a perspective view of the breakable area of FIG. 22 comprising a plurality of airbags.

FIG. 28 is a perspective view of the energy absorber of FIG. 2 positioned on a structure.

FIG. 29 is a graph showing projected reductions in head accelerations on monument designs that incorporate energy absorbers within potential head strike zones.

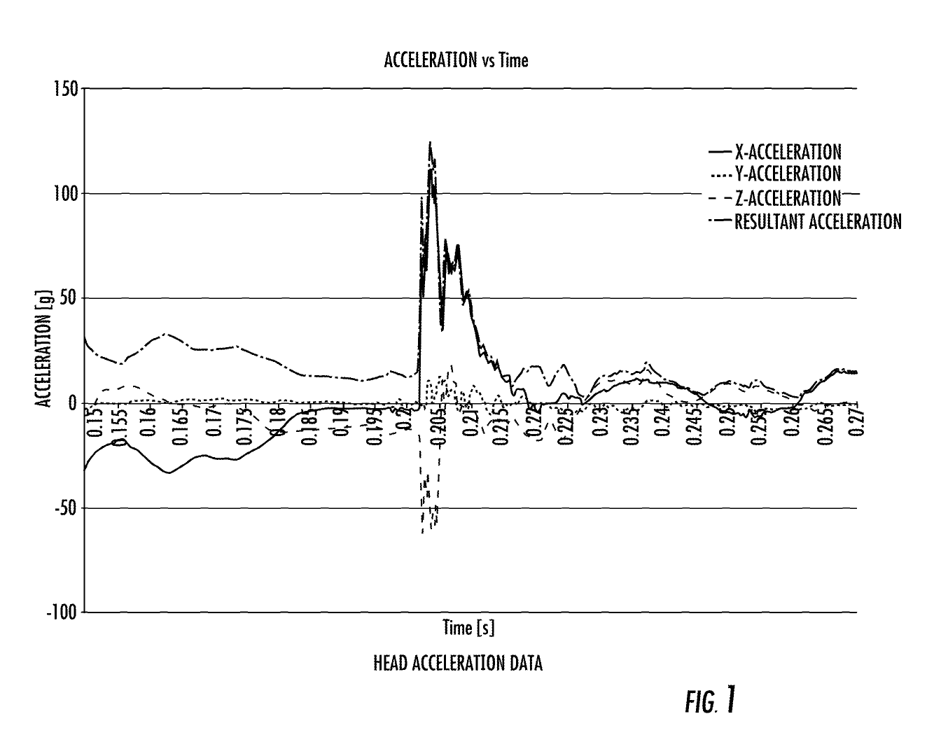

### DETAILED DESCRIPTION

The described embodiments of the invention provide energy absorbers for passenger seats. While the energy absorbers are discussed for use with aircraft seats, they are by no means so limited. Rather, embodiments of the energy absorbers may be used in passenger seats or other seats of any type or otherwise as desired.

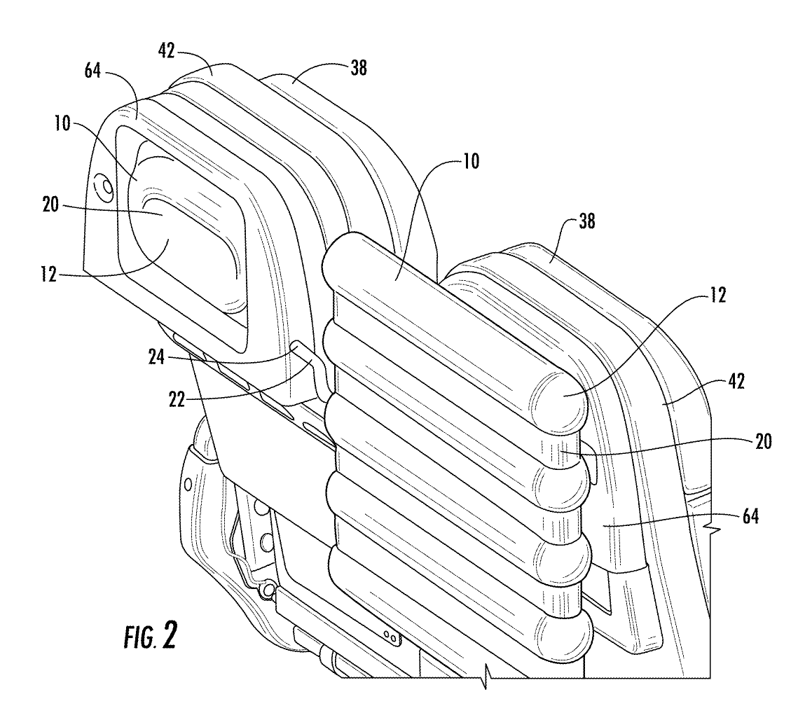

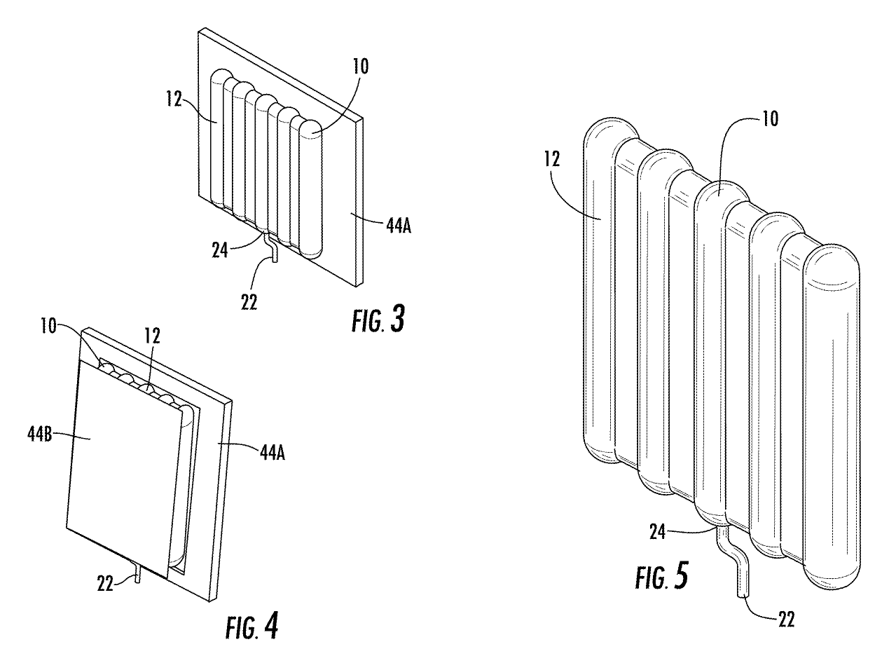

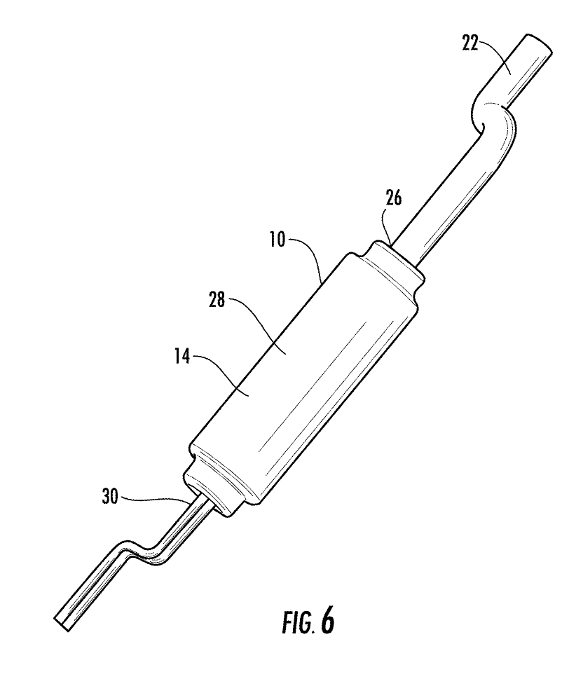

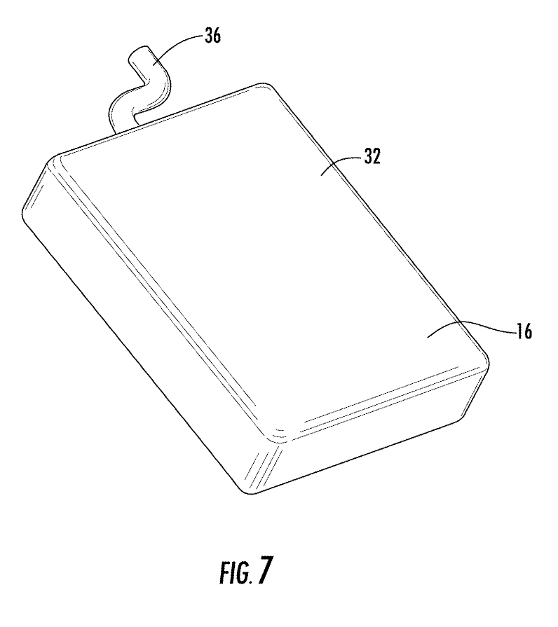

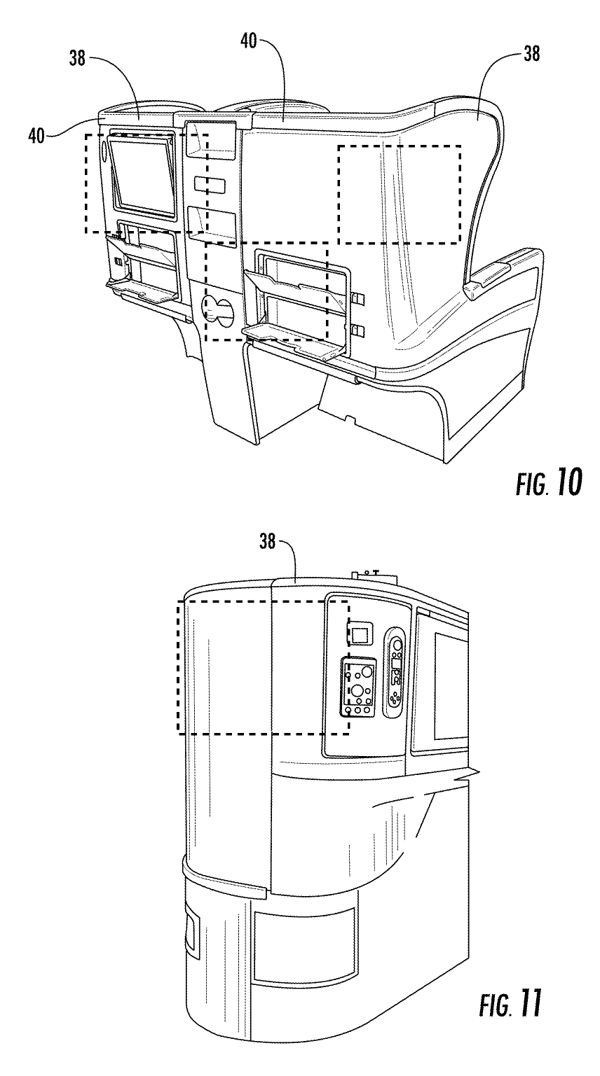

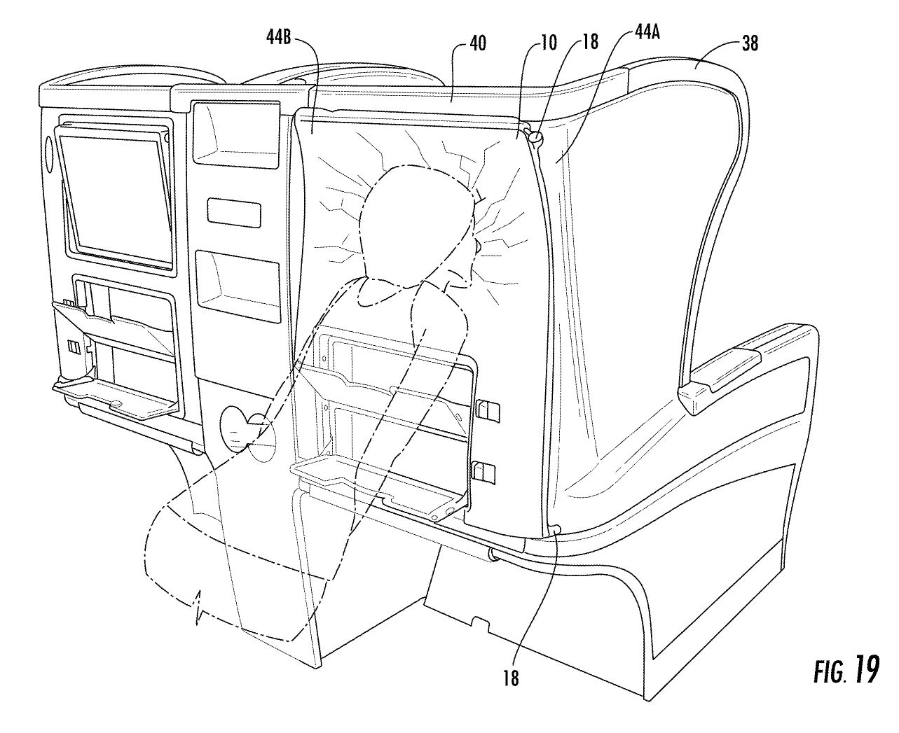

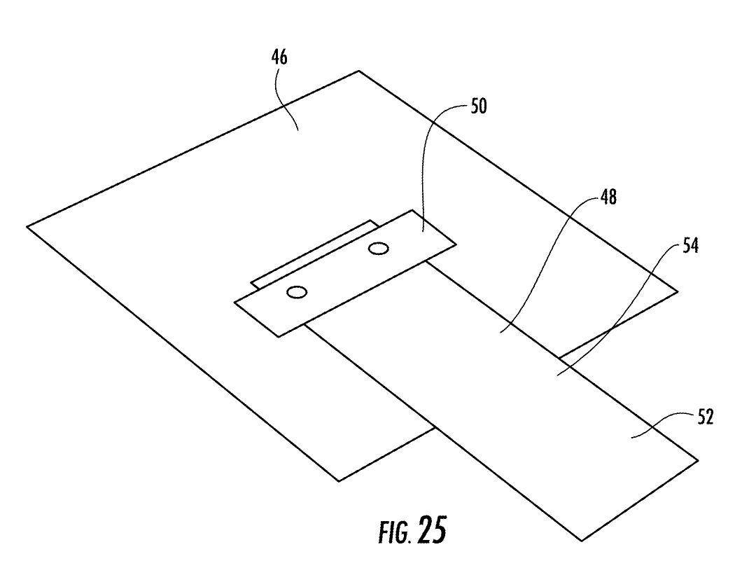

FIGS. 2-20 and 22-28 illustrate embodiments of an energy absorber 10. In these embodiments, the energy absorber 10 comprises at least one airbag 12, an inflator 14, and a control module 16. The energy absorber 10 may further comprise at least one mechanical energy absorber 18. The energy absorber 10 may be formed of standard aerospace and automotive materials including but not limited to composite plastics, aluminum, stainless steel, other metallic materials, composite materials, or other similar materials. Furthermore, the energy absorber 10 may be configured to be formed from minimal parts with a plug and play design to reduce assembly costs.

The airbag 12 may be formed of a thin, nylon fabric or other suitable flexible materials. In some embodiments, as shown in FIGS. 2-5 and 12, the airbag 12 may include a rectilinear, oval, circular, or other overall deployed shape as needed for the location where the energy absorber 10 is mounted. Furthermore, the airbag 12 may include an indented surface 20. The indented surface 20 may include any suitable configuration that may reduce or control occupant head acceleration, as discussed in more detail below. The airbag 12 may further comprise vent locations to assist with airbag deflation.

As illustrated in FIGS. 2-6, a gas hose 22 may be coupled to a port 24 in the airbag 12 and to a port 26 of the inflator 14. In some embodiments, the gas hose 22 may be integrally formed with the airbag 12 and/or the inflator 14. In other embodiments, the gas hose 22 may be coupled to the airbag 12 and/or the inflator 14 via any suitable mechanical or chemical fasteners including but not limited to adhesives, adhesion welding, or other suitable fastening methods. In yet other embodiments, the inflator 14 may be coupled directly to the airbag 12 without the need for the gas hose 22.

The inflator 14 may further comprise a canister 28. The canister 28 may be a high pressure gas vessel or other suitable container designed to withstand application of pressure up to 600 bar. The canister 28 may further helium gas to rapidly inflate the airbag 12. However, one of ordinary skill in the relevant art will understand that any suitable chemical composition may be included within the canister 28 that produces a gas that rapidly inflates the airbag 12 within the time period needed. A firing module 30 may be coupled to the inflator 14. The firing module 30 may include a pyrotechnic squib that will break a membrane in order to release the pressurized Helium gas.

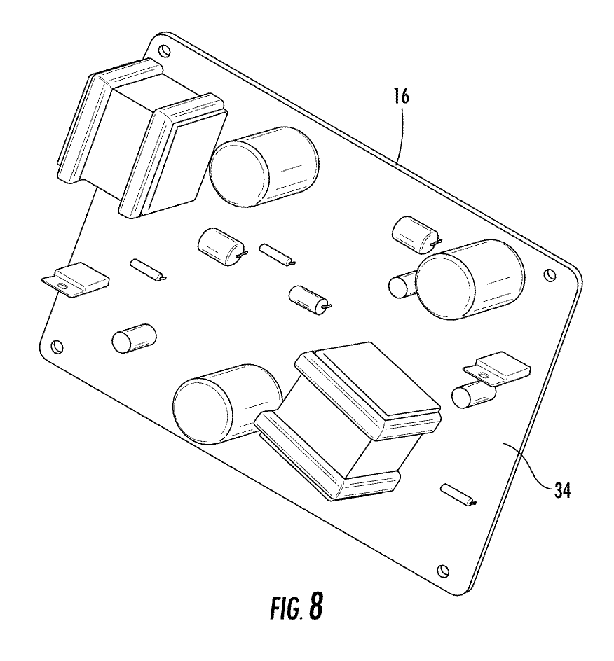

In certain embodiments, as shown in FIGS. 7-8, the control module 16 may comprise a housing 32, a control board 34, and an electrical harness 36. The control module 16 may be electrically connected to the inflator 14 and the firing module 30 via the electrical harness 36. The housing 32 may be formed of plastics or other suitable materials and may be configured to substantially surround and protect the control board 34. The control board 34 may include a battery for reserve power and inflator firing charge capability. The control board 34 may also include integrated logic to monitor for crash scenarios and to deploy the energy absorber 10 when such a scenario is detected.

According to certain embodiments, as illustrated in FIGS. 2, 9-12, 15-17, 19-20, 22, and 28, the energy absorber 10 may be positioned within and/or attached to a front of a structure 38. Typical structures 38 may include monuments 40 and/or seat backs 42 or other suitable structures where a passenger's head or other body part may come into contact with hard points of a cabin interior or another seat. Monuments 40 may include but are not limited to class dividers, closets, cabinets, bulkheads, furniture, rigid partitions, or other similar structures. In these embodiments, the energy absorber 10 is shaped and sized to protect a passenger during a crash by guiding the occupant's extremities and/or limiting the energy imparted into the structure 38.

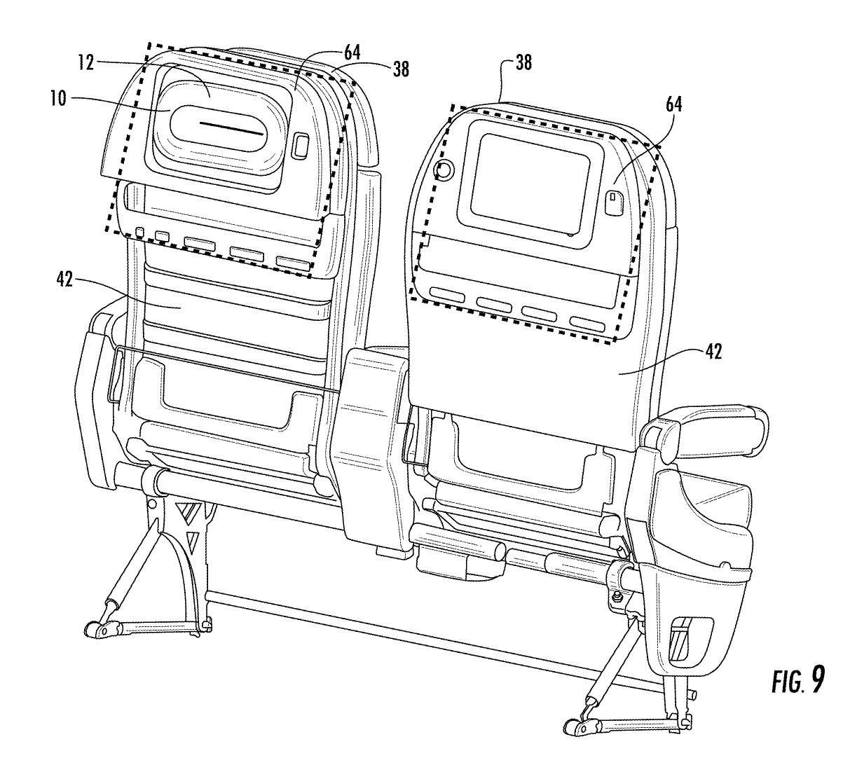

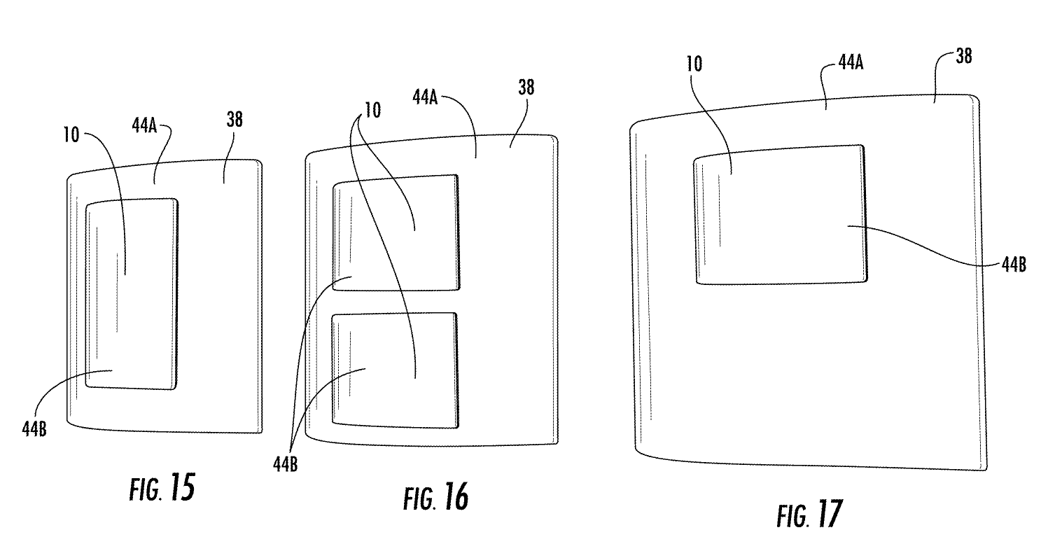

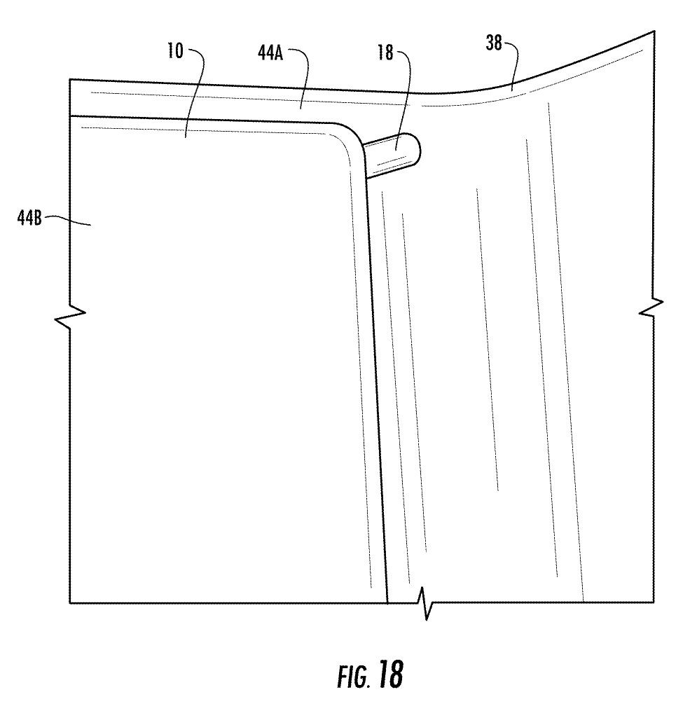

Suitable locations for the energy absorber 10 within or on the structures 38 may include potential head or body strike areas, as indicated by broken line squares in FIGS. 9-12. The energy absorber 10 may be configured to form a crash surface for a passenger's entire body (FIG. 15), head (FIGS. 16 and 17), knees (FIG. 16), or any suitable combination thereof

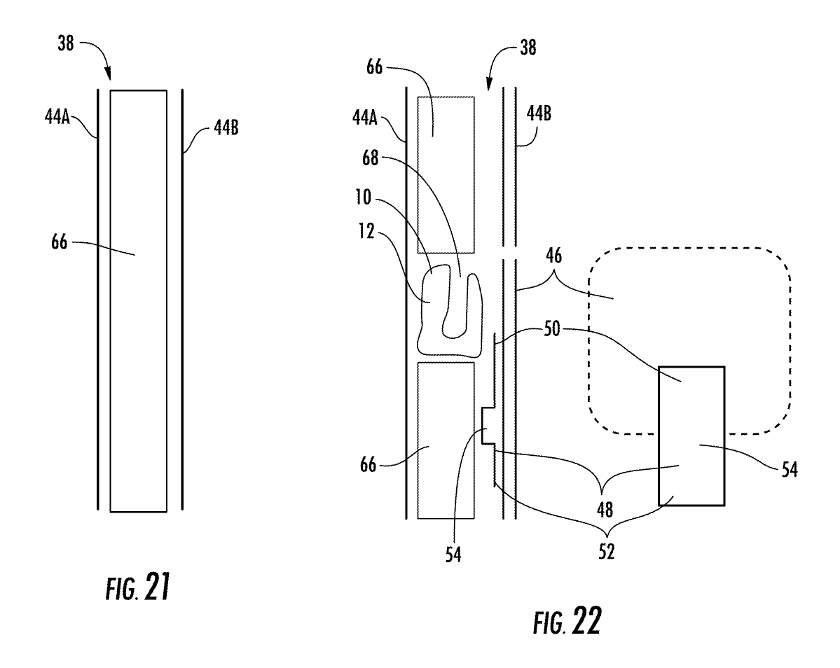

FIG. 21 illustrates a typical internal construction of the structure 38. In this construction, an internal material 66, such as a honeycomb structure or other suitable structure that provides sufficient strength and support for the structure 38, is sandwiched between an inner surface 44A and an outer surface 44B. When the energy absorber 10 is positioned within the structure 38, as shown in FIG. 22, a portion of the internal material 66 is removed to create a pocket 68 within which the airbag 12 may be stowed.

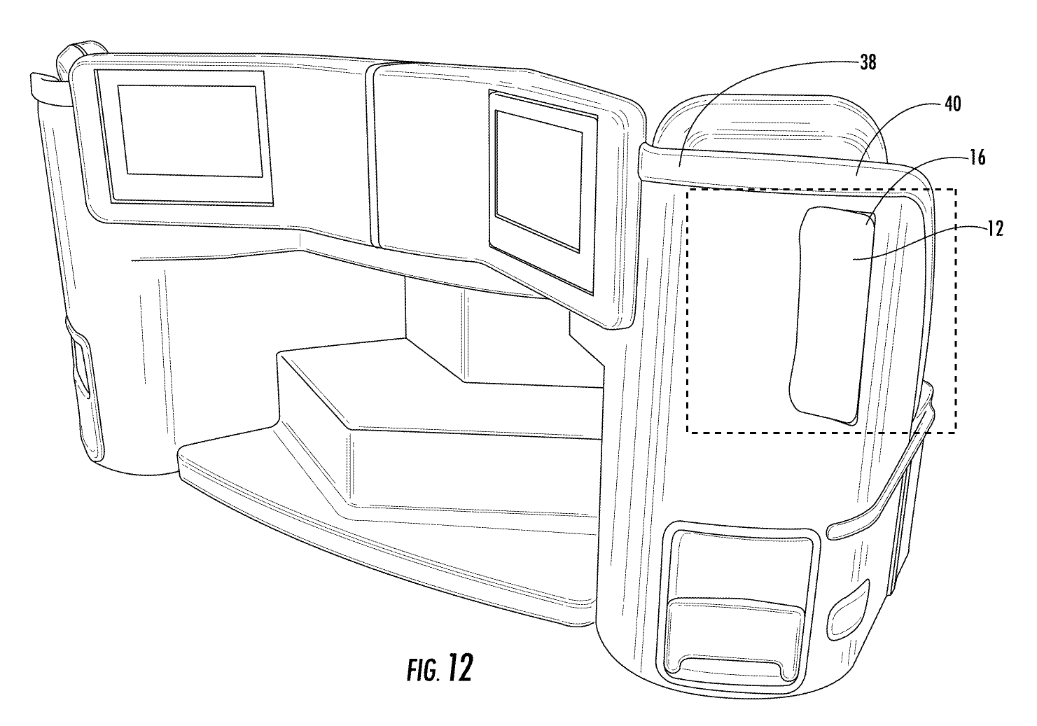

In certain embodiments, in order for the airbag 12 to freely escape the pocket 68, as shown in FIGS. 12 and 22-25, the outer surface 44B may comprise a breakable area 46 to allow the airbag 12 to deploy through the outer surface 44B. The breakable area 46 may be formed by partially cutting or otherwise weakening the outer surface 44B locally in a shape that that allows the airbag 12 to correctly deploy. The breakable area 46 should retain sufficient strength to withstand ordinary wear and tear usage, while also being configured to break quickly when the airbag 12 is deployed. For example, the breakable area 46 may be formed of composite materials, glass fibers, fabric, Kevlar with resin, or other suitable materials.

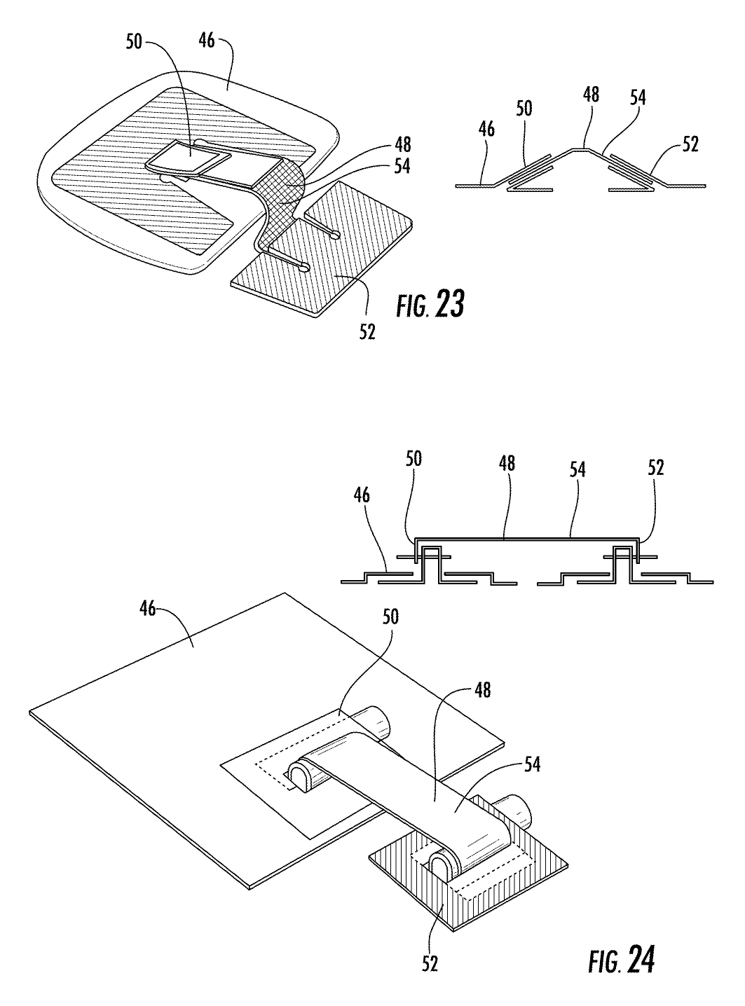

In these embodiments, as illustrated in FIGS. 22-25, the breakable area 46 may be configured to be weaker on one side and stronger on an opposing side, wherein a first end 50 of a hinge 48 may be coupled to the breakable area 46 and a second end 52 of the hinge 48 may be coupled to a remainder of the outer surface 44B. In certain embodiments, as shown in FIGS. 23-25, each end of the hinge 48 may be adhered, bonded, sewn, mechanically coupled, or otherwise joined to the breakable area 46 and the outer surface 44B.

As shown in FIGS. 23-25, the two ends 50, 52 of the hinge 48 may be connected via a flexible connector 54. The flexible connector 54 may comprise a tether or strap or other suitable design that will provide a strong and flexible hinge that will not interfere with the egress of the airbag 12 during deployment. In certain embodiments, the hinge 48 may be positioned at a lower side of the breakable area 46 so that the breakable area 46 rotates down and out of the way of the airbag 12 during deployment. However, one of ordinary skill in the relevant art will understand that the hinge 48 may have any suitable design and/or position that allows the airbag 12 to deploy without interference.

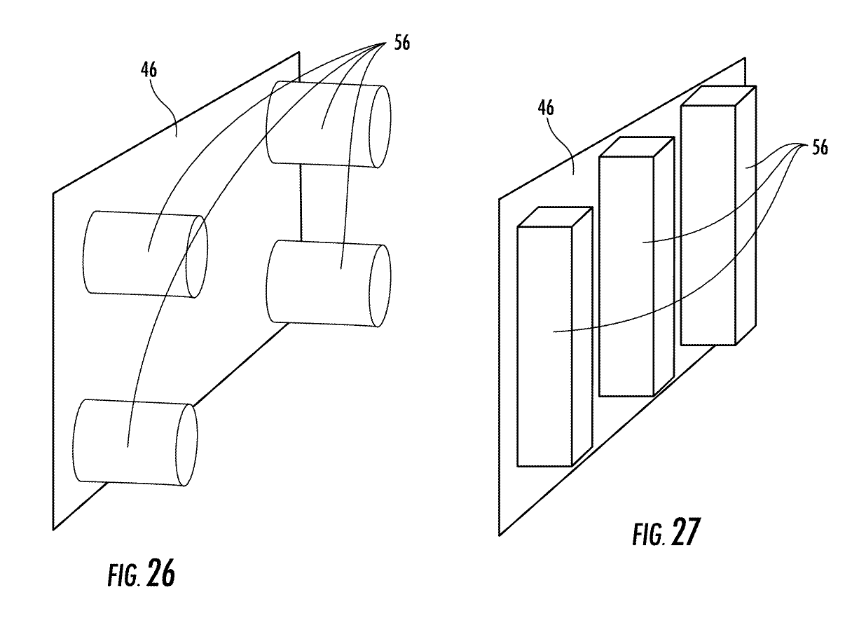

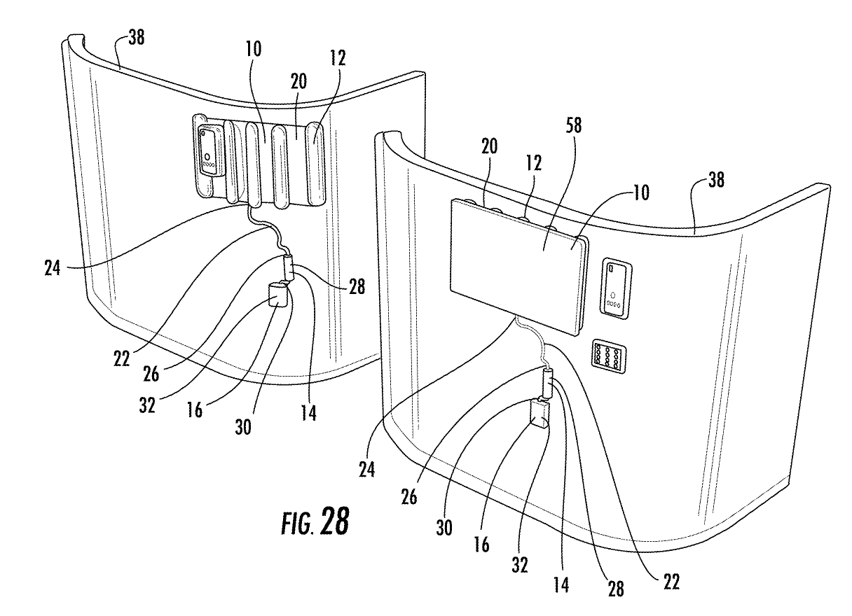

In certain embodiments, as illustrated in FIGS. 26-27, the breakable area 46 may comprise one or more small airbags 56 mounted to its surface and connected together with tubes. The airbags 56 may be positioned in any suitable location and in any suitable number on the breakable area 46. By incorporating a plurality of airbags 56 with the breakable area 46 in strategic locations, the amount of volume needed for the airbags 56 may be reduced, while providing crash protection for the breakable area 46 surface. In other words, the breakable area 46 may comprise a surface area that is greater than an inflated surface area of the airbags 56 so that the breakable area 46 forms part of the absorbing surface.

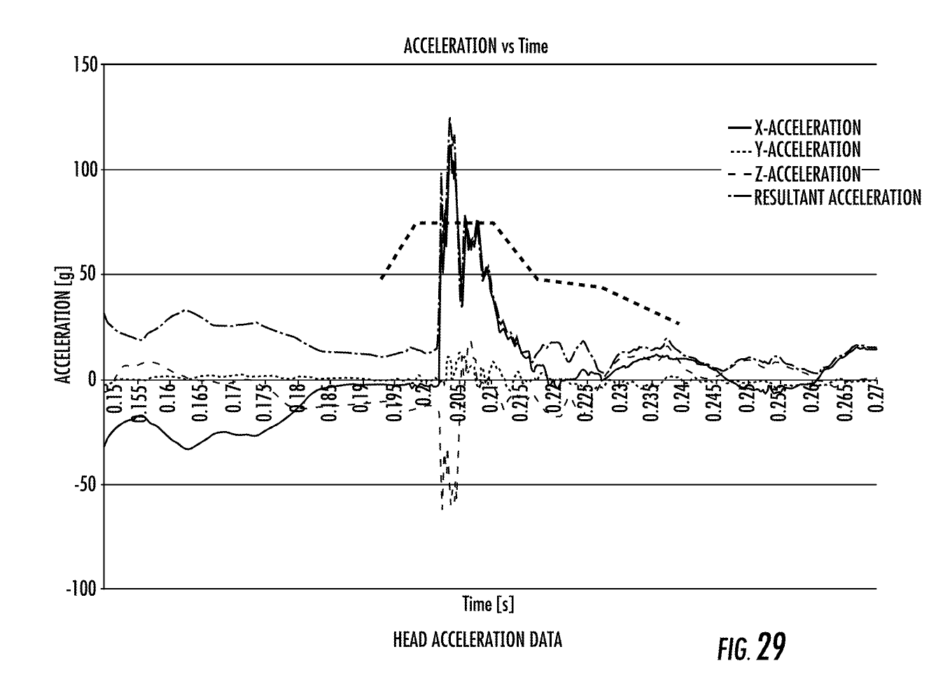

Furthermore, as best illustrated in FIG. 28, the energy absorber 10 may be configured to be mounted to and/or extend through the outer surface 44B prior to deployment. In these embodiments, a cover 58 may also be positioned over and coupled to the airbag 12, which may also comprise the plurality of airbags 56 as described above. Thus, the cover 58 may serve a similar purpose as the breakable area 46 without the need for the airbag 12 to deploy through the outer surface 44B.

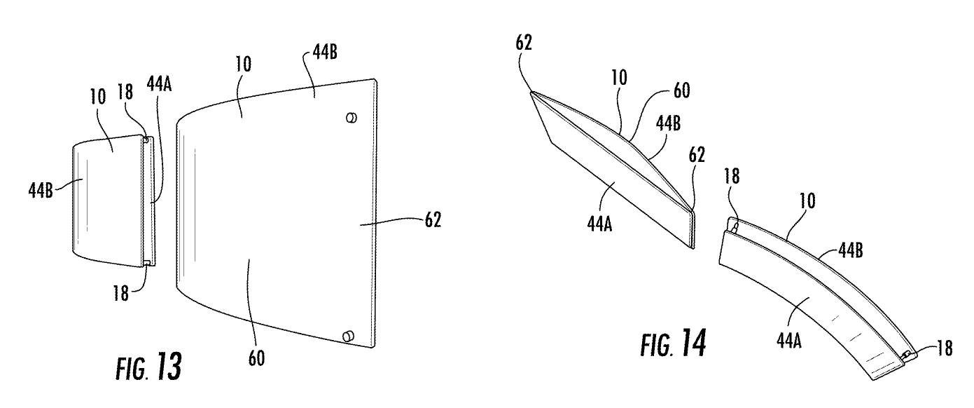

In certain embodiments, as illustrated in FIGS. 13-18, the energy absorber 10 and the outer surface 44B may have a deflector deployed configuration or an absorber deployed configuration. In the deflector deployed configuration, as best illustrated in FIGS. 13-14, the energy absorber 10 may be configured so that the airbag 12 causes a central portion 60 of the outer surface 44B to be displaced from the inner surface 44A when the airbag is inflated, while edges 62 of the outer surface remain substantially proximate the inner surface 44A. As a result, when the energy absorber 10 is deployed, the central portion 60 of the outer surface 44B may be displaced approximately 2 to 4 inches (or any other suitable distance needed to absorb energy) during inflation, thus forming a cushioned chamber between the two surfaces 44A, 44B to reduce and/or control passenger head acceleration.

In the absorber deployed configuration, as best illustrated in FIGS. 13-19, the energy absorber 10 in combination with the mechanical energy absorbers 18 may be positioned between the surfaces 44A, 44B. The mechanical energy absorbers 18 may be configured to cause the entire outer surface 44B to be displaced from the inner surface 44A when the airbag 12 is inflated. For example, the mechanical energy absorbers 18 may include a telescoping design that is compressed prior to deployment so that the outer surface 44B is positioned proximate the inner surface 44A and/or the internal material 66, but expands when the airbag 12 inflates and locks into the expanded position, thereby forming a pocket between the inner surface 44A and the outer surface 44B so that the outer surface 44B remains displaced from the inner surface 44A after the airbag 12 deflates.

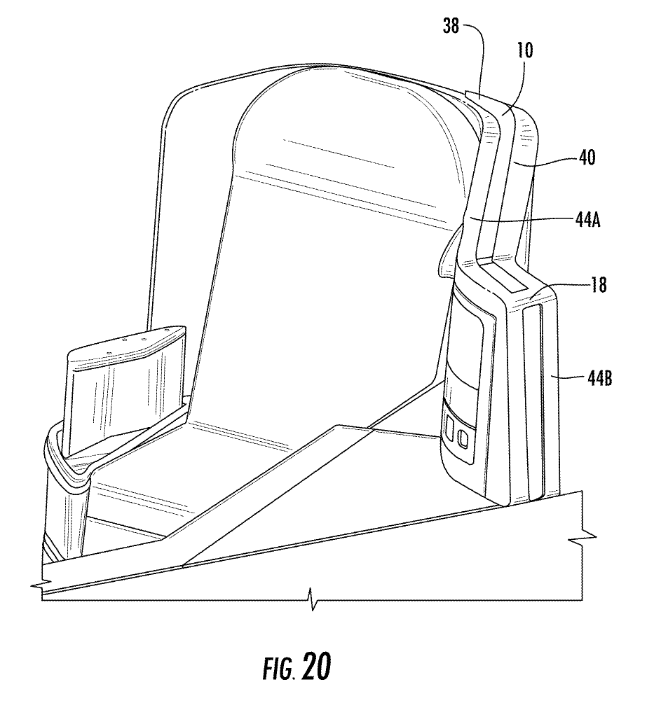

In certain embodiments, the mechanical energy absorbers 18 may be positioned adjacent the corners of the outer surface 44B. However, one of ordinary skill in the relevant art will understand that the mechanical energy absorbers 18 may be placed in any suitable location and in any suitable numbers to allow the outer surface 44B to be displaced as needed. As a result, when the energy absorber 10 is deployed, the entire outer surface 44B may be displaced approximately 2 to 4 inches (or any other suitable distance needed to absorb energy) during inflation, thus forming a cushioned chamber between the two surfaces 44A, 44B to reduce and/or control passenger head acceleration. For example, FIG. 19 illustrates a passenger's head crashing into a deployed outer surface 44B in an absorber deployed configuration. The space created between the outer surface 44B and the inner surface 44A allows for impact absorption from the passenger's head strike, which in turn lowers the passenger's head acceleration.

In the embodiments where the energy absorber 10 is attached to the seat back 42, as shown in FIGS. 2, 9, 10, and 19, the airbag 12 may be positioned behind or in front of a component 64, such as a video display or other passenger accessory or entertainment device. The inflator 14 may be integrated into the seat back 42 frame. The control module 16 may also be installed on the seat back 42 frame to minimize wiring and to ensure modularity. The airbag 12 may be deployed behind or in front of the component 64, as illustrated in FIG. 2.

FIG. 29 illustrates head accelerations experienced on structures 38 having energy absorbers 10 installed within the head strike zones. As shown in FIG. 29, the incorporation of the energy absorbers 10 reduces the highest spikes in acceleration and also provides better control and predictability over the head acceleration values that would be experienced in the event of a minor crash. Furthermore, incorporation of the energy absorbers 10 into structures 38 also reduces the allowable setback for non-contact installations.

The foregoing is provided for purposes of illustrating, explaining, and describing embodiments of the present invention. Further modifications and adaptations to these embodiments will be apparent to those skilled in the art and may be made without departing from the scope or spirit of the invention.

That which is claimed is:

1. An energy absorber for a structure within a vehicle cabin comprising:
(a) a plurality of airbags;
(b) an inflator coupled to the plurality of airbags, wherein the inflator comprises a canister and a firing module;
(c) a control module electrically connected to the firing module of the inflator;
(d) an outer surface positioned adjacent the plurality of airbags, wherein the outer surface comprises a surface area that is greater than an inflated surface area of the plurality of airbags; and
(e) a plurality of mechanical energy absorbers positioned adjacent the plurality of airbags and coupled to the outer surface.

2. The energy absorber of claim 1, further comprising an inner surface, wherein the outer surface is coupled to the inner surface in a deflector deployed configuration so that a central portion of the outer surface is displaced from the inner surface when the plurality of airbags are inflated.

3. The energy absorber of claim 1, further comprising an inner surface, wherein the outer surface is coupled to the inner surface in an absorber deployed configuration so that the outer surface is displaced from the inner surface when the plurality of airbags are inflated.

4. The energy absorber of claim 1, wherein the control module comprises integrated logic to monitor for crash scenarios and to deploy the energy absorber when such a scenario is detected.

5. The energy absorber of claim 1, wherein the structure is a monument or a passenger seat back.

6. An energy absorber for a structure within a vehicle cabin comprising:
(a) a plurality of airbags;
(b) an inflator coupled to the plurality of airbags, wherein the inflator comprises a canister and a firing module;
(c) a control module electrically connected to the firing module of the inflator; and
(d) an outer surface comprising a breakable area positioned adjacent the plurality of airbags, wherein the breakable area comprises a weaker coupling to the outer surface on at least a first side and a stronger coupling to the outer surface on at least a second side, wherein the breakable area comprises a surface area that is greater than an inflated surface area of the plurality of airbags.

7. The energy absorber of claim 6, further comprising a hinge comprising a first end coupled to the breakable area and a second end coupled to a remainder of the outer surface.

8. The energy absorber of claim 7, wherein the first end and the second end are connected via a flexible connector.

9. The energy absorber of claim 6, wherein the breakable area is displaced approximately 2 to 4 inches during inflation of the plurality of airbags.

10. The energy absorber of claim 6, wherein the control module comprises integrated logic to monitor for crash scenarios and to deploy the energy absorber when such a scenario is detected.

11. The energy absorber of claim 6, further comprising a plurality of mechanical energy absorbers positioned adjacent the plurality of airbags and coupled to the outer surface.

12. The energy absorber of claim 6, further comprising an inner surface, wherein the outer surface is coupled to the inner surface in a deflector deployed configuration so that a central portion of the outer surface is displaced from the inner surface when the plurality of airbags are inflated.

13. The energy absorber of claim 6, further comprising an inner surface, wherein the outer surface is coupled to the inner surface in an absorber deployed configuration so that the outer surface is displaced from the inner surface when the plurality of airbags are inflated.

14. The energy absorber of claim 6, wherein the structure is a monument or a passenger seat back.

15. A monument for a passenger seat comprising:
(a) an inner surface;
(b) an outer surface spaced apart from the inner surface;
(c) an energy absorber comprising:
(i) at least one airbag positioned in the space between the inner surface and the outer surface;
(ii) an inflator coupled to the at least one airbag, wherein the inflator comprises a canister and a firing module; and
(iii) a control module electrically connected to the firing module of the inflator; and
(d) at least one mechanical energy absorber positioned adjacent the at least one airbag and coupled to the inner surface and the outer surface.

16. The monument of claim 15, wherein the outer surface comprises a breakable area positioned adjacent the at least one airbag, wherein the breakable area comprises a weaker coupling to the outer surface on at least a first side and a stronger coupling to the outer surface on at least a second side.

17. The energy absorber of claim 16, further comprising a hinge comprising a first end coupled to the breakable area and a second end coupled to a remainder of the outer surface.

18. The energy absorber of claim 17, wherein the first end and the second end are connected via a flexible connector.

19. The energy absorber of claim 16, wherein the breakable area is formed of composite materials, glass fibers, fabric, or Kevlar with resin.

20. The energy absorber of claim 15, wherein the control module comprises integrated logic to monitor for crash scenarios and to deploy the energy absorber when such a scenario is detected.
